(19) United States
(12) Patent Application Publication
(10) Pub. No.: US 2011/0178782 A1
(43) Pub. Date: Jul. 21, 2011

(54) Method for Estimating Geometric Error Between Linear Axis and Rotary Axis in a Multi-Axis Machine Tool

(75) Inventors: Seung-Han Yang, Daegu (KR); Dong-Mok Lee, Daegu (KR); Kwang-II Lee, Yeongcheon-si (KR); Zankun Zhu, Daegu (KR)

(73) Assignee: Kyungpook National University Industry-Academic Cooperation Foundation, Daegu (KR)

(21) Appl. No.: 12/769,285

(22) Filed: Apr. 28, 2010

(30) Foreign Application Priority Data
Jan. 19, 2010 (KR) 10-2010-0004868

(51) Int. Cl. G06F 17/10

(52) U.S. Cl. 703/2

(57) ABSTRACT

A method of estimating a geometric error between a linear axis and a rotary axis in a multi-axis machine tool is provided, the method including creating a circular path under the control of one or more drive axes and measuring a radial error of the circular path using a ball bar, defining the relationship between position-dependent geometric error parameters and position-independent geometric error parameters and measured data using an error synthesis model and an equation of a ball bar, defining a linear equation with unknown position-independent geometric error parameters by removing higher order terms of the position-dependent geometric error parameters and position-independent geometric error parameters, and obtaining the position-independent geometric error parameters through least squares from the linear equation.

### CROSS REFERENCE TO RELATED APPLICATION

The present application claims priority from Korean Patent Application Number 10-2010-0004868 filed on Jan. 19, 2010, the entire contents of which application is incorporated herein for all purposes by this reference.

### BACKGROUND OF THE INVENTION

1. Field of the Invention

The present invention relates in general to a multi-axis machine tool having one or more linear axes and one or more rotary axes, and more particularly, to a method for estimating and evaluating the geometric error between a linear axis and a rotary axis.

2. Description of Related Art

Generally, multi-axis machine tools are machine tools having two or more drive axes, such as multi-joint robots, coordinate measuring machines (CMMs) or the like. Such multi-axis machine tools generally include one or more linear axes and one or more rotary axes. As a representative example, a 5-axis machine tool is provided, and has three linear axes and two rotary axes so as to realize machining of a complex curved surface or shape.

However, the multi-axis machine tool essentially has geometric error between the linear axis and the rotary axis because of the existence of physical defects and of limitation of assembly. Particularly, such a geometric error becomes an important factor in determining geometrical accuracy owing to structural problems occurring due to the combination of the linear axis and the rotary axis.

Geometric error includes position-dependent geometric error parameters (PDGEPs) and position-independent geometric error parameters (PDGEPs). The PDGEPs include three position errors (1 displacement error and 2 straightness errors) and three angle errors (roll, pitch, and yaw errors), and the PDGEPs include squareness and offset errors.

Meanwhile, in the currently available measuring technique, several methods of measuring the PDGEPs have been proposed. However, most such methods do not take into account effects of the PDGEPs, such as linear displacement error, straightness, angular error, or the like in a drive axis.

The information disclosed in this Background of the Invention section is only for the enhancement of understanding of the background of the invention and should not be taken as an acknowledgment or any form of suggestion that this information forms a prior art that would already be known to a person skilled in the art.

### BRIEF SUMMARY OF THE INVENTION

Various aspects of the present invention provide a method of measuring position-independent geometric error parameters between a linear axis and a rotary axis of a multi-axis machine tool, which includes one or more linear axes and one or more rotary axes, taking into account position-dependent geometric error parameters of a drive axis, and then evaluating geometric error between the linear axis and the rotary axis.

In an aspect of the present invention, the present invention provides a method of estimating the geometric error between a linear axis and a rotary axis in a multi-axis machine tool having one or more linear axes and one or more rotary axes, the method including the steps of: creating a circular path, which is capable of measuring the geometric error of the multi-axis machine tool, under the control of one or more drive axes, and measuring the radial error of the circular path using a ball bar; defining the relationship between position-dependent geometric error parameters and position-independent geometric error parameters of the multi-axis machine tool and data measured using the ball bar, using an error synthesis model and an equation pertaining to the ball bar; defining a linear equation with unknown position-independent geometric error parameters by removing higher order terms of the position-dependent geometric error parameters and position-independent geometric error parameters; and obtaining the position-independent geometric error parameters through least squares from the linear equation.

In an exemplary embodiment, the multi-axis machine tool may be 5-axis machine tool in a type of tilting head.

In an exemplary embodiment, the linear equation is Ax=b, where A is a matrix consisting of coefficients of the position-independent geometric error parameters, b is a column vector that is calculated using the radial error, the geometric error, and error parameters pertaining to the geometric error, and x is a column vector consisting of unknown position-independent geometric error parameters.

In an exemplary embodiment, the step of measuring the radial error of the circular path may be implemented by connecting first and second balls to a tool body and a workpiece bed, respectively, of the 5-axis machine tool.

In an exemplary embodiment, the step of measuring the radial error of the circular path may include: for measurement of the offset error, simultaneously driving a first linear feed axis and a first rotary table, connected to the tool body of the 5-axis machine tool, and creating the circular path; and for measurement of squareness, simultaneously driving the first linear feed axis and the first rotary table, connected to the tool body of the 5-axis machine tool, and a third linear feed axis, connected to the workpiece bed, and creating the circular path.

In an exemplary embodiment, the step of defining the linear equation for measurement of the offset error may include obtaining an equation, RΔR=α₁e_{XB}+α₂e_{ZB}+h₁, using the radial error and the error parameters, and deriving, from the obtained equation, the linear equation in a type of matrix, where R is a reference radius of the circular path, ΔR is the radial error measured using the ball bar, e_{XB} and e_{ZB} are the offset errors, α₁=(x−x₀(1−cos θ)+(z−z₀(1−sin θ), α₂=(z−z₀)(1−cos θ)−(x−x₀)sin θ, h1 is the error parameter pertaining to the geometric error of the drive axis, x and z are coordinates of the circular path, x₀ and z₀ are center points of the circular path, and θ is a rotation angle of the first rotary table.

In an exemplary embodiment, the step of defining the linear equation for measurement of squareness may include obtaining an equation, RΔR=α₃s_{XB}+α₄s_{ZB}+h₂, and deriving, from the obtained equation, the linear equation in a type of matrix, where R is a reference radius of the circular path, ΔR is the radial error measured using the ball bar, α₃=(y−y₀)(−l_{ZB}+l_{ZB} cos θ−l_{XB} sin θ), and α₃=(y−y₀)(l_{XB}−l_{XB} cos θ−l_{ZB} sin θ), s_{XB} and s_{ZB} are the squareness, h2 is the error parameter pertaining to the geometric error of the drive axis, y is the coordinate of the circular path, y₀ is the center coordinate of the circular path, θ is a rotation angle of the first rotary table, l_{XB} and l_{ZB} are distances of the coordinate system between the first linear feed axis and the first rotary table of the multi-axis machine tool.

According to exemplary embodiments of the present invention as set forth above, the position-independent geometric error parameters can be measured taking into account the geometric error between the linear axis and the rotary axis in the multi-axis machine tool, particularly the position-dependent geometric error parameters of the drive axis. The circular path is created by simultaneously driving the linear and rotary axis and the radial error of the circular path is measured using the ball bar, with the result that the geometric error between the linear axis and the rotary axis is estimated, having in particular the effect of simple, accurate measurement of the geometric error of the head tilting type 5-axis machine tool.

The methods of the present invention have other features and advantages which will be apparent from, or are set forth in more detail in, the accompanying drawings, which are incorporated herein, and in the following Detailed Description of the Invention, which together serve to explain certain principles of the present invention.

### BRIEF DESCRIPTION OF THE DRAWINGS

FIG. 1 is a flow diagram illustrating a method of estimating the geometric error between a linear axis and a rotary axis in a multi-axis machine tool according to the present invention;

FIG. 2 is a perspective view illustrating a tilting head type 5-axis machine tool as an example of a multi-axis machine tool, to which the present invention is adapted;

FIG. 3 is a view illustrating a coordinate system and the geometric error of the tilting head type 5-axis machine tool;

FIG. 4 is a view illustrating the construction of a ball bar;

FIG. 5 is a view illustrating an exemplary circular path which is created for measuring the ball bar;

FIG. 6 is a view illustrating a method of measuring the ball bar for estimating the offset error of the geometric error according to an embodiment of the present invention; and

FIG. 7 is a view illustrating a method of measuring the ball bar for estimating the squareness of the geometric error according to another embodiment of the present invention.

### DETAILED DESCRIPTION OF THE INVENTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments that may be included within the spirit and scope of the invention as defined by the appended claims.

Throughout this document, reference should be made to the drawings, in which the same reference numerals and signs are used throughout the different drawings to designate the same or similar components. In the following description of the present invention, detailed descriptions of known functions and components incorporated herein will be omitted when they may make the subject matter of the present invention unclear.

{i} is a coordinate system of a drive axis i, and i is one of X, Y, Z, B, and C.

{F} is a reference coordinate system.

δⱼᵢ is a translational error of the drive axis i in the direction of j, wherein i is X, Y, Z, B, or C, and j is X, Y or Z.

εⱼᵢ is the angular error of the drive axis i in the direction of j, wherein i is X, Y, Z, B or C, and j is X, Y or Z.

eⱼᵢ is the offset error of the drive axis i in the direction of j, wherein i is X, Y, Z, B or C, and j is X, Y or Z.

sⱼᵢ is the squareness of the drive axis i in the direction of j, wherein i is X, Y, Z, B, or C, and j is X, Y, or Z.

ΔR is the radial error of a circular path measured using a ball bar.

x, y, and z are coordinates of the circular path created by the ball bar, x₀, y₀, and z₀ are center coordinates of the circular path, Δx, Δy, and Δz are position errors at coordinates of X, Y, and Z, and l_{XB} and l_{ZB} are distances of {B} and {Z} coordinate systems in a multi-axis machine tool.

pᵢⱼ is a position vector of i in a {j} coordinate system, Tᵢⱼ is a transformation matrix from coordinate system {i} to coordinate system {j}, Dᵢ is a matrix including position-independent geometric error parameters for the drive axis i, Eᵢ is a matrix including position-dependent geometric error parameters for the drive axis i, and Nᵢ is a matrix including no errors at all, wherein i is X, Y, Z, B, or C. Oᵢⱼ is a matrix indicative of the distance between the coordinate system {i} and the coordinate system {j}, θ is the rotation angle of a workpiece bed, and φ is the position at the respective measuring points.

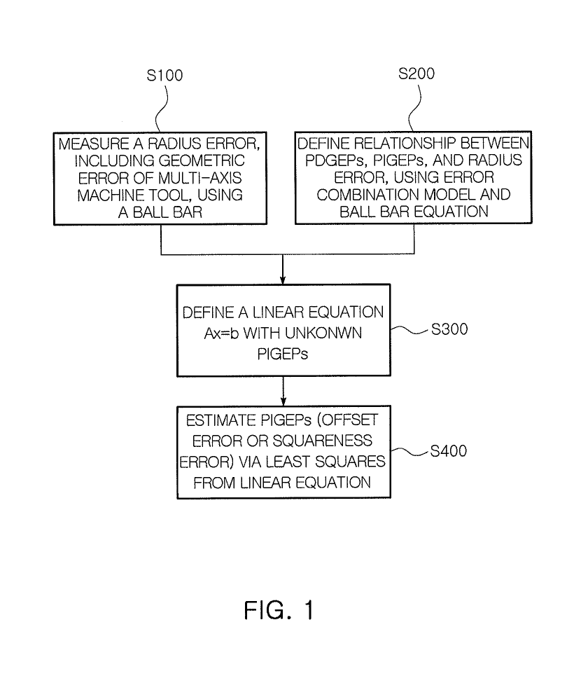

FIG. 1 is a flow diagram illustrating the method of estimating the geometric error between a linear axis and a rotary axis in a multi-axis machine tool according to the present invention.

Referring to FIG. 1, a method of estimating the geometric error between a linear axis and a rotary axis in a multi-axis machine tool having one or more linear axes and one or more rotary axes includes the steps of measuring a radial error, including the geometric error, using a ball bar (S100), defining the relationship between position-dependent geometric error parameters and position-independent geometric error parameters of the multi-axis machine tool, and measured radial error, using an error combination model and an equation pertaining to the ball bar (S200), defining a linear equation with unknown position-independent geometric error parameters by removing higher order terms of the position-dependent geometric error parameters and position-independent geometric error parameters (S300), and estimating the position-independent geometric error parameters through least squares from the linear equation (S400).

Prior to describing the respective steps of the method in detail, geometric errors that are to be measured with the present invention will be defined.

The present invention is intended to measure the geometric error between a linear axis and a rotary axis of a multi-axis machine tool, more particularly position-independent geometric error parameters (offset error, squareness or the like). Particularly, the present invention is useful for measuring the geometric error of a tilting head type 5-axis machine tool having a tilting head and a rotary table.

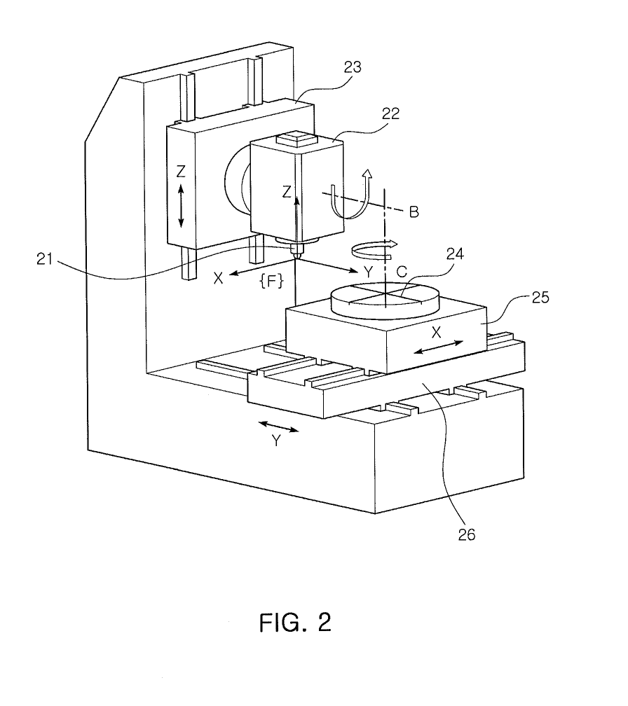

FIG. 2 is a perspective view illustrating the tilting head type 5-axis machine tool as an example of a multi-axis machine tool to which the present invention is adapted.

Referring to FIG. 2, the 5-axis machine tool includes a first linear feed axis 23 that moves linearly in a Z direction, a first rotary table 22 that is fixed to the first linear feed axis 23 so as to rotate about a Y-axis, a tool body 21 fixed to the first rotary table 22, a second linear feed axis 26 that moves linearly in a Y direction, a third linear feed axis 25 that is fixed to the second linear feed axis 26 so as to linearly move in an X direction, and a second rotary table 24 that is fixed to the third linear feed axis 25 so as to rotate about a Z-axis. In the 5-axis machine tool, the second rotary table 24 becomes a workpiece bed to which a workpiece is fixed.

The drive axis of the 5-axis machine tool includes three linear feed axes X, Y, and Z, and two rotary axes B and C.

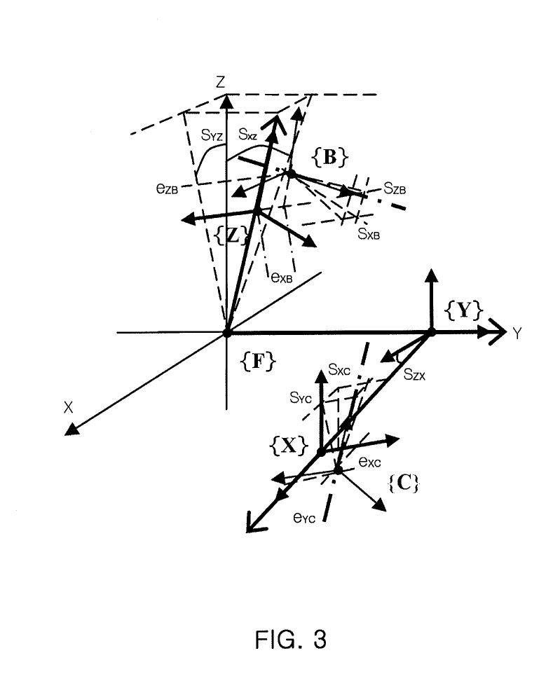

The coordinate system and geometric errors of the 5-axis machine tool as illustrated in FIG. 2 are defined as in FIG. 3.

In FIG. 3, {F} is a reference coordinate, {B} and {C} are coordinate systems of the first and second rotary tables 22 and 24, and {Z}, {Y}, and {X} are coordinate systems of the first, second and third linear feed axes 23, 26, and 25. s_{XC}, s_{YC}, s_{XB}, s_{ZB}, s_{XZ}, s_{YZ}, and s_{ZX} are squarenesses, and e_{XB}, e_{ZB}, e_{XC}, and e_{YC} are offset errors. Since the squarenesses s_{XZ}, s_{YZ}, and s_{ZX} in the position-independent geometric error parameters can be measured with conventional methods, the present invention aims at measuring the other position-independent geometric error parameters s_{XC}, s_{YC}, s_{XB}, s_{ZB}, e_{XB}, e_{ZB}, e_{XC}, and e_{YC}.

The position-dependent geometric error parameters (E) and position-independent geometric error parameters (D) of the drive axis i of the 5-axis machine tool can be expressed using homogeneous transformation matrices (HTM).

$$\begin{matrix}{E}_{i} = [ \begin{matrix}1 & - {ɛ}_{Zi} & {ɛ}_{Yi} & {δ}_{Xi} \\ {ɛ}_{Zi} & 1 & - {ɛ}_{Xi} & {δ}_{Yi} \\ - {ɛ}_{Yi} & {ɛ}_{Xi} & 1 & {δ}_{Zi} \\ 0 & 0 & 0 & 1\end{matrix} ] \\ {D}_{i} = [ \begin{matrix}1 & - {S}_{Zi} & {S}_{Yi} & {e}_{Xi} \\ {S}_{Zi} & 1 & - {S}_{Xi} & {e}_{Yi} \\ - {S}_{Yi} & {S}_{Xi} & 1 & {e}_{Zi} \\ 0 & 0 & 0 & 1\end{matrix} ]\end{matrix}$$

The position of the tool body 21 in the reference coordinates {F} can be expressed using Equation 1.

P_{F}^{T}=τ_{T}^{F}τ_{B}^{Z}P_{T}^{B} Equation 1

In Equation 1, τ_{T}^{F}=D_{z}N_{z}E_{z}, and τ_{B}^{Z}=O_{ZB}D_{B}E_{B}N_{B}.

The transformation matrix from the coordinate system of the workpiece to the reference coordinate system is as follows.

τ_{W}^{F}=τ_{Y}^{F}τ_{X}^{Y}τ_{C}^{X}τ_{W}^{C}, Equation 2

In Equation 2, τ_{Y}^{F}N_{Y}E_{Y}, τ_{X}^{Y}=D_{X}N_{X}E_{X}and τ_{C}^{X}=O_{CX}D_{C}E_{C}N_{C}.

Finally, the position of the tool body in the coordinate system of the workpiece can be expressed as Equation 3.

P_{T}^{W}=(τ_{W}^{F})⁻¹P_{T}^{F} Equation 3

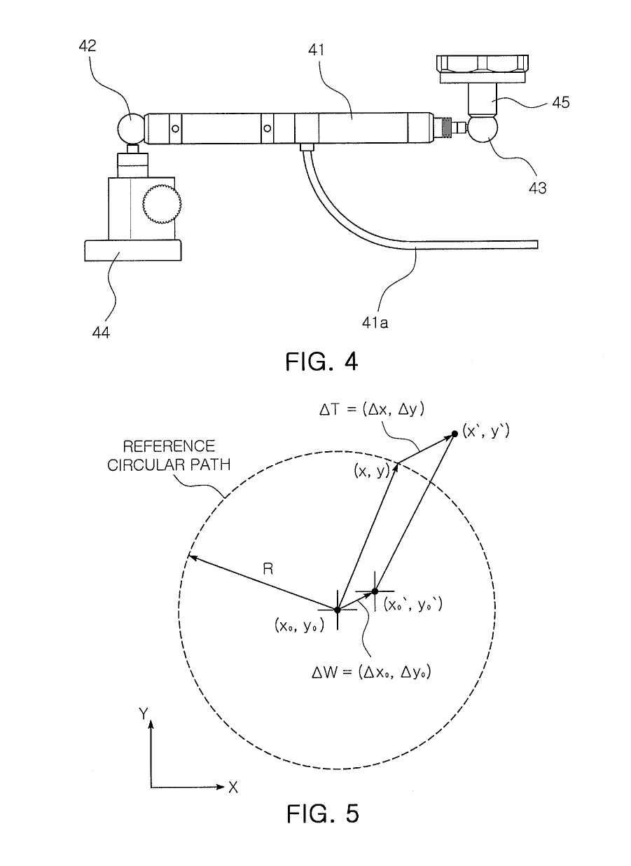

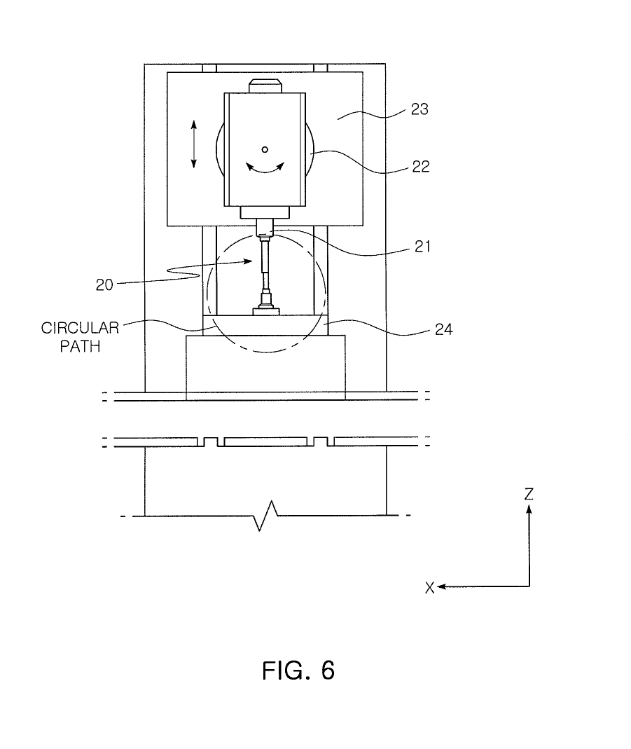

In order to measure the geometric error in the 5-axis machine tool, the ball bar shown in FIG. 4 is used.

Referring to FIG. 4, the ball bar is configured such that two fixing mills, i.e. first and second balls 42 and 43, are connected to opposite ends of a telescoping bar 41, to which first and second sockets 44 and 45 are respectively fixed by means of magnetic force. The telescoping bar 41 measures the distance between the first and second balls 42 and 43 via LVDT, which is provided inside the telescoping bar, and outputs the measured data via a data collecting cable 41a.

In the present invention, the first ball 42 is fixed to the workpiece bed, i.e. the second rotary table 24, of the 5-axis machine tool, the second ball 43 is fixed to the tool body 21 of the 5-axis machine tool 21, and the 2-axis or 3-axis drive axes are simultaneously controlled so that the tool body 21 is rotated to create a circular path. Here, the center of the created circular path becomes the position of the first ball 42, and the coordinates of the circular path become the position of the second ball 43. The radial error of the circular path occurring due to the geometric errors of the 5-axis machine tool is measured using the telescoping bar 41.

FIG. 5 is a view illustrating an exemplary circular path which is created. Here, the circular path is created in the X-Y plane.

In FIG. 5, (x₀, y₀) is the nominal center of the circular path created by one end of the ball bar (first ball 42), R is a reference distance between the first and second balls 42 and 43 as a reference radius and (x, y) are coordinates of the circular path created by the other end of the ball bar (second ball 43). If the ball bar is installed on the multi-axis machine tool, the first and second balls 42 and 43 are moved by a linear axis and a rotary axis which include the geometric errors. At this moment, the center is called (x₀′, y₀′), and the coordinates of the circular path are called (x′, y′).

Here, the measured data of the ball bar becomes a radial distance R+ΔR of the circular path including the error, wherein R is the reference radius of the circular path, and ΔR is a radial error.

In the multi-axis machine tool, considering the geometrical relationship between the drive axes and the relationship between data measured using the ball bar, an equation pertaining to the ball bar can be defined as equation 4.

RΔR=(x−x₀)(Δx−Δx₀)+(y−y₀)(Δy−Δy₀) Equation 4

Here, (Δx, Δy) and (Δx₀, Δy₀) are position errors of opposite ends of the ball bar, i.e. the first and second balls 42 and 43, which are distorted by the geometric error of the multi-axis machine tool.

The radial error ΔR is directly related to the geometric error of the multi-axis machine tool.

In order to estimate the geometric errors, particularly the position-independent geometric error parameters, from the measured data, the present invention derives a linear equation having unknown position-independent geometric error parameters as in equation 5, using the data measured using the ball bar.

Ax=b Equation 5

Here, A is a matrix consisting of coefficients of position-independent geometric error parameters, b is a column vector that is calculated taking into account the radial error and the geometric error of the drive axis, which are measured using the ball bar, and x is an unknown that consists of position-independent geometric error parameters. x, i.e. the position-independent geometric error parameter, is calculated through least squares from equation 5.

Measurement of Offset Error

A description will be made of the procedure of measuring offset error among position-independent geometric error parameters of the multi-axis machine tool in accordance with the present invention.

For the measurement of offset error, the first and second balls of the ball bar 20 are respectively fixed to the tool body 21 and the workpiece bed (the second rotary table 24) of the multi-axis machine tool, and the first rotary table 22 and the first linear feed axis 23 for moving the tool body 21 are simultaneously controlled so as to create a circular path. The circular path is created in the X-Y plane by the movement of the first rotary table 22 and the first linear feed axis 23, wherein the center of the circular path becomes (0, z₀), and a function of the circular path is defined as equation 6.

l_{XB}−l_{XB} cos θ−l_{ZB} sin θ=R sin θ

l_{XB}+z+z₀−l_{ZB} cos θ+l_{XB} sin θ=R cos φ Equation 6

In the 5-axis machine tool, since l_{XB} equals 0, the equation 6 can be expressed as equation 7.

−l_{ZB} sin θ=R sin φ

l_{ZB}+z−z₀−l_{ZB} cos θ=R cos φ Equation 7

Further, since in the 5-axis machine tool, only the first linear feed axis 23 and the first rotary table 22 are driven, the first ball 42, which is fixed to the workpiece bed, becomes the center of the circular path, and the position of the second ball 43, which is connected to the tool body 21, becomes the coordinates of the circular path. Here, the position P_{T}^{F} of the tool body in the reference coordinate system {F} equals equation 1, wherein P_{T}^{B} is expressed as equation 8.

P_{T}^{B}=(τ_{B}^{Z})⁻¹[0 0 0 1]^{T} Equation 8

Here, τ_{B}^{Z}=O_{BZ}D_{B}.

The position P_{W}^{F} of the workpiece in the reference coordinates {F} is given as equation 9.

P_{W}^{F}=τ_{Z}^{F},z₀[0 0 1]^{T} Equation 9

Where τ_{Z}^{F}, z₀ is a transformation matrix from the coordinate system {Z} to the coordinate system {F} as the drive axis Z moves towards zₒ.

In the equations 7 to 9, if the positions of the first and second balls 42 and 43 are indicated as P_{T}^{F}* and P_{W}^{F}* when all the errors equal 0, volumetric errors, ΔT=P_{T}^{F}−P_{T}^{F}* and ΔW=P_{W}^{F}−P_{W}^{F}*, are combined with the equation 4, so that equation 10 can be obtained.

RΔR=α₁e_{XB}+α₂e_{ZB}+h₁ Equation 10

Here, α₁=(x−x₀)(1−cos θ)+(z−z₀)sin θ,

α₂=(z−z₀)(1−cos θ)−(x−x₀)sin θ,

h₁={δ_{XB}+δ_{XZ}−δ_{XZ}_{₀}+ε_{YZ}l_{ZB}+s_{YZ}l_{ZB}+s_{YZ}^{Z}−s_{YZ}z₀−l_{ZB}(ε_{YB}+ε_{YZ}+s_{YZ})cos θ+l_{XB}(ε_{YB}+ε_{YZ}+s_{YZ})sin θ}(x−x₀)+{δ_{ZB}+δ_{ZZ}−δ_{ZZ}_{₀}−ε_{YZ}l_{XB}−s_{YZ}l_{XB}+l_{XB}(ε_{YB}+ε_{YZ}+s_{YZ})cos θ+l_{ZB}(ε_{YB}+ε_{YZ}+s_{YZ})}(z−z₀),

x=−l_{ZB} sin θ, x₀=0 and z=l_{ZB}+z−l_{ZB} cos θ.

The equation 10 can be modified as RΔR−h₁=α₁e_{XB}+α₂e_{ZB}.

Thus, according to the present invention, in the step S100, the circular path is created and the radial error ΔR of the circular path is measured using the ball bar, in the step S200, the relationship between the position-independent geometric error parameters, the position-dependent geometric error parameters, and the measured radial error is defined using the error synthesis model and the equation of the ball bar to obtain the error parameter h₁. Then, in the step S300, the higher order terms of the position-independent geometric error parameters and the position-dependent geometric error parameters are eliminated, so that the equation of the ball bar having unknown position-independent geometric error parameters, such as equation 10, is obtained for each measuring points. Then, a linear equation having unknown offset error, such as equation 5, is derived from the equations.

Then, in the step S400, the unknown offset errors e_{XB} and e_{ZB} are obtained via least squares from the linear equation.

Measurement of Squareness

In the present method of measuring the geometric errors, squareness is measured using the following procedure.

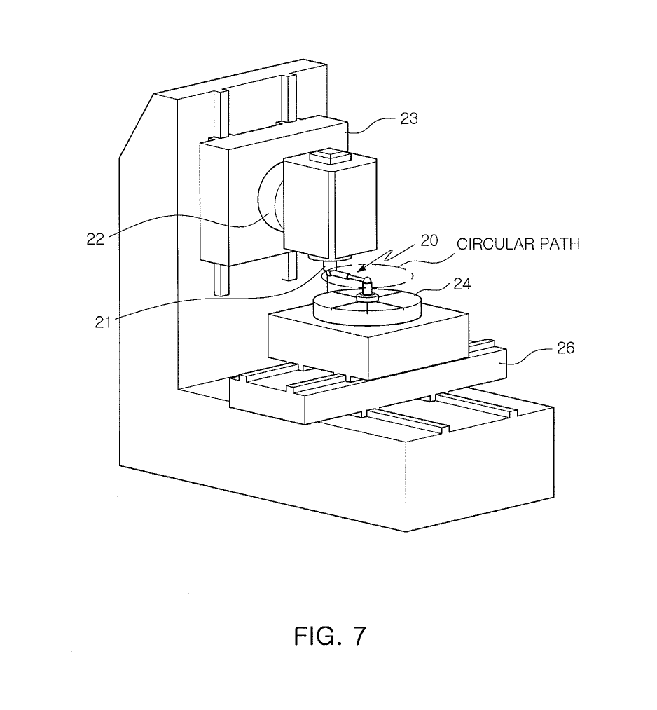

For the measurement of squareness, the ball bar 20 is fixed to the tool body 21 and the workpiece bed (the second rotary table 24) of the 5-axis machine tool, as shown in FIG. 7, and the first rotary table 22, the first linear feed axis 23, and the second linear feed axis 26 are simultaneously controlled so as to create a circular path. The circular path is created in the X-Y plane under the control of the first rotary table 22, the first linear feed axis 23, and the second feed axis 26. The circular path can be expressed as equation 11.

−l_{ZB} sin θ=R sin φ

Y=R cos φ and

l_{ZB}+z−l_{ZB} cos θ=z₀ Equation 11

The center of the circular path becomes the first ball 42, which is fixed to the workpiece bed, and the coordinates of the circular path become the position of the second ball 43, which is connected to the tool body. Since, in the 5-axis machine tool, only the first rotary table 22 and the first and second linear feed axes 23 and 26 are driven, an error model can be established based only on the rotation axis B, the linear axis Z and Y, and the reference coordinate system {F}.

Here, since the position p_{T}^{F} of the circular path, i.e. the tool body, is determined using equations 1 and 8, as in measuring the offset error, and the center of the circular path, i.e. the position of the first ball 42, is determined using the drive axis Y, equation 12 is obtained.

P_{W}^{F}=τ_{T}^{F}P_{W}^{Y} Equation 12

Here, since T_{Y}^{F} equals the equation 2, the position of the first ball 42 in the coordinate system {Y} is expressed as equation 13.

P_{W}^{Y}=(τ_{Y,Y}_{₀}^{F})⁻¹τ_{Z,Z}_{₀}^{F}[0 0 0 1]⁻¹ Equation 13

Here τ_{Y,Y}_{₀}^{F} is a transformation matrix from the coordinate system {Y} to the coordinate system {F} as the drive axis Y moves towards y₀, and τ_{Z,Z}_{₀}^{F} is a transformation matrix from the coordinate system {Z} to the coordinate system {F} as the drive axis Z moves towards zₒ.

In the equations 1 and 12, if the positions of the first and second balls 42 and 43 are indicated as P_{T}^{F}* P_{W}^{F}* when all the error components equal 0, volumetric errors, ΔT=P_{T}^{F}−P_{T}^{F}* and ΔW=P_{W}^{F}−P_{W}^{F}*, are combined with equations 4 and 13, so that equation 14 can be obtained.

RΔR=α₃s_{XB}+α₄s_{zb}+h₂ Equation 14

Here, α₃=(y−y₀)(−l_{ZB}+l_{ZB} cos θ−l_{XB} sin θ),

α₄=(y−y₀)(l_{XB}−l_{XB} cos θ−l_{XB} sin θ),

h₂={δ_{XB}+δ_{XY}−δ_{XZ}+ε_{YZ}l_{ZB}+ε_{XB}+s_{YZ}l_{ZB}−p+ε_{ZY}y₀+ε_{ZY}q+s_{YZ}z−z₀−s_{YZ}γ−(l_{XB}+ε_{YB}l_{ZB}+ε_{YZ}l_{ZB}+ε_{XB}+s_{YZ}l_{ZB})cos θ+(ε_{YB}l_{XB}+ε_{YZ}l_{XB}−ε_{ZB}+s_{YZ}l_{ZB})sin θ}(x−x₀)+{δ_{YB}+δ_{YY}−δ_{YZ}+ε_{ZZ}l_{ZB}+ε_{XZ}l_{ZB}−s_{XZ}l_{ZB}−ε_{ZY}p−q+ε_{XY}z₀+s_{YZ}z₀+s_{XY}z₀+ε_{XY}γ−ε_{ZB}l_{XB}−ε_{ZZ}l_{XB}+l_{XB}(ε_{XB}+ε_{XZ}+s_{XZ})cos θ−(ε_{XB}l_{XB}+ε_{XZ}l_{ZB}+ε_{ZZ}l_{ZB}+s_{XZ}l_{XB})sin θ}(y−y₀),

p=−δ_{XY0}+δ_{XZ0}−ε_{ZY0}y₀−ε_{YY}z₀,

q=δ_{YY0}+δ_{YZ0}+ε_{XY0}z₀,

r=−δ_{ZY0}+δ_{ZZ0}+ε_{XY0}y₀,

x=−l_{ZB} sin θ, y=0 and x₀=0.

The equation 14 can be modified as RΔR−h₂=α₃s_{XB}+α₄s_{ZB}.

Thus, according to the present invention, in the step S100, the circular path is created under the control of the first rotary table 22, and the first and second linear feed axes 23 and 26, and the radial error ΔR of the circular path is measured using the ball bar; in the step S200, the relationship between the position-independent geometric error parameters, the position-dependent geometric error parameters, and the measured radial error is defined using the error synthesis model and the equation of the ball bar to obtain the error parameter h₂. Then, in the step S300, the higher order terms of the position-independent geometric error parameters and the position-dependent geometric error parameters are eliminated so that the equation of the ball bar having unknown position-independent geometric error parameters, such as equation 14, is obtained for each measuring point. Then, the linear equation having squareness, such as equation 5, is derived from the equations.

Then, in the step S400, the unknown squarenesses s_{XB} and s_{ZB} are estimated via least squares from the linear equation.

Simulation Results

In order to verify the reliability of the present estimating method for the geometric error, computer simulation has been implemented. The computer simulation was performed in such a manner that after assuming geometric errors of a drive axis, a radial error is calculated using the assumed errors and the circular path, which is created for measurement by the ball bar, based on an error synthesis model, and the position-independent geometric error parameters are estimated using the radial error.

Table 1 indicates machine parameters used in this computer simulation and assumed geometric errors, and Table 2 shows the simulation results.

TABLE 1

| Machine Parameters | Assumed Geometric Errors |
|---|---|
| R = 150 mm | e_{XB} = 8 μm |
| l_{XB} = 0 mm | e_{ZB} = 6 μm |
| l_{ZB} = 400 mm | e_{XC} = 5 μm |
| | e_{YC} = 6 μm |
| | s_{ZX} = 30.94 arcsec |
| | s_{YZ} = 45.38 arcsec |
| | s_{XZ} = 51.57 arcsec |
| | s_{XB} = 37.13 arcsec |
| | s_{ZB} = 28.88 arcsec |
| | s_{XC} = 33.00 arcsec |
| | s_{YC} = 41.25 arcsec |

TABLE 2

| Geometric | | Estimated | |
|---|---|---|---|
| Errors | Assumed Value | Value | Difference |
| e_{XB} | 8 μm | 7.7 μm | −0.3 μm |
| e_{ZB} | 6 μm | 5.9 μm | −0.1 μm |
| s_{XB} | 37.13 arcsec | 36.91 arcsec | −0.22 arcsec |
| s_{ZB} | 28.88 arcsec | 29.31 arcsec | 0.43 arcsec |

As shown in the results of Table 2, it was found that the assumed values and the measured values of the position-independent geometric error parameters were similar to each other. Thus, it was also known that the present measuring method is effective for estimating the position-independent geometric error parameters in the multi-axis machine tool, particularly the tilting head type 5-axis machine tool.

The foregoing descriptions of specific exemplary embodiments of the present invention have been presented for the purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A method of estimating a geometric error between a linear axis and a rotary axis in a multi-axis machine tool having one or more linear axes and one or more rotary axes, the method comprising the steps of:
creating a circular path, which is capable of measuring the geometric error of the multi-axis machine tool, under the control of one or more drive axes, and measuring a radial error of the circular path using a ball bar;
defining a relationship between position-dependent geometric error parameters and position-independent geometric error parameters of the multi-axis machine tool, and data measured using the ball bar, using an error synthesis model and an equation pertaining to the ball bar;
defining a linear equation with unknown position-independent geometric error parameters by removing higher order terms of the position-dependent geometric error parameters and position-independent geometric error parameters; and
obtaining the position-independent geometric error parameters through least squares from the linear equation.

2. The method according to claim 1, wherein the multi-axis machine tool is 5-axis machine tool in a type of tilting head.

3. The method according to claim 1, wherein the linear equation is
Ax=b,
where A is a matrix consisting of coefficients of the position-independent geometric error parameters, b is a column vector that is calculated using the radial error, the geometric error, and error parameters pertaining to the geometric error, and x is a matrix consisting of unknown position-independent geometric error parameters.

4. The method according to claim 2, wherein the step of measuring the radial error of the circular path is implemented by connecting first and second balls to a tool body and a workpiece bed, respectively, of the 5-axis machine tool.

5. The method according to claim 4, wherein the step of measuring the radial error of the circular path comprises:
for the measurement of offset error, simultaneously driving a first linear feed axis and a first rotary table, connected to the tool body of the 5-axis machine tool, and creating the circular path.

6. The method according to claim 4, wherein the step of measuring the radial error of the circular path comprises:
for the measurement of squareness, simultaneously driving the first linear feed axis and the first rotary table, connected to the tool body of the 5-axis machine tool, and a third linear feed axis, connected to the workpiece bed, and creating the circular path.

7. The method according to claim 5, wherein the step of defining the linear equation comprises:
for each measuring point, obtaining the equation pertaining to the ball bar,
RΔR=α₁e_{XB}+α₂e_{ZB}+h₁ and
deriving, from the obtained equation, the linear equation in a type of matrix,
where R is a reference radial of the circular path, ΔR is the radial error measured using the ball bar, e_{XB} and e_{ZB} are the offset errors,
α₁=(x−x₀)(1−cos θ)+(z−z₀)sin θ and
α₂=(z−z₀)(1−cos θ)−(x−x₀)sin θ,
h₁ is the error parameter pertaining to the geometric error of the drive axis, x and z are coordinates of the circular path, x₀ and z₀ are center points of the circular path, and θ is a rotation angle of the first rotary table.

8. The method according to claim 6, wherein the step of defining the linear equation comprises:
for each measuring point, obtaining the equation pertaining to the ball bar,
RΔR=α₃s_{XB}+α₄s_{ZB}+h₂,
and deriving, from the obtained equation, the linear equation in a type of matrix,
where R is a reference radius of the circular path, AR is the radial error measured using the ball bar,
α₃=(y−y₀)(−l_{ZB}+l_{ZB} cos θ−l_{XB} sin θ) and
α₄=(y−y₀)(l_{XB}−l_{XB} cos θ−l_{ZB} sin θ),
s_{XB} and s_{ZB} are the squareness, h₂ is the error parameter pertaining to the geometric error of the drive axis, y is the coordinate of the circular path, y₀ is the center coordinate of the circular path, θ is a rotation angle of the first rotary table, l_{XB} and l_{ZB} are distances of the coordinate system between the first linear feed axis and the first rotary table of the multi-axis machine tool.

9. The method according to claim 7, wherein the error parameter h₁ is expressed as follows:
h₁={δ_{XB}+δ_{XZ}−δ_{XZ}_{₀}+ε_{YZ}l_{ZB}+s_{YZ}l_{ZB}+s_{YZ}z−s_{YZ}z₀−l_{ZB}(ε_{YB}+ε_{YZ}+s_{YZ})cos θ+l_{XB}(ε_{YB}+ε_{YZ}+s_{YZ})sin θ}(x−x₀)+{δ_{ZB}+δ_{ZZ}−δ_{ZZ}_{₀}−ε_{YZ}l_{XB}−s_{YZ}l_{XB}+l_{ZB}(ε_{YB}+ε_{YZ}+s_{YZ})cos θ+l_{ZB}(ε_{YB}+ε_{YZ}+s_{YZ})}(z−z₀),
where x=−l_{ZB} sin θ, x₀=0 and z=l_{ZB}+z−l_{ZB} cos θ,
δⱼᵢ is a translational error of the drive axis i in a direction of j,
εⱼᵢ is an angular error of the drive axis i in the direction of j,
sⱼᵢ is the squareness of the drive axis i in the direction of j,
x, y, and z are coordinates of the circular path, and
x₀, y₀, and z₀ are center coordinates of the circular path.

10. The method according to claim 8, wherein the error parameter h₂ is expressed as follow:
h₂={δ_{XB}+δ_{XY}−δ_{XZ}+ε_{YZ}l_{ZB}+ε_{XB}+s_{YZ}l_{ZB}−p+ε_{ZY}y₀+ε_{ZY}q+s_{YZ}z−s_{YY}−z₀−s_{YZ}γ−(l_{XB}+ε_{YB}l_{ZB}+ε_{YZ}l_{ZB}+ε_{XB}+s_{YZ}l_{ZB})cos θ+(ε_{YB}l_{XB}+ε_{YZ}l_{XB}−ε_{ZB}+s_{YZ}l_{ZB})sin θ}(x−x₀)+{δ_{YB}−δ_{YY}+δ_{YZ}+ε_{ZZ}l_{ZB}−ε_{XZ}l_{ZB}−s_{XZ}l_{ZB}−ε_{ZY}p−q−s_{YZ}z+ε_{XY}z₀+s_{YZ}z₀+s_{XY}z₀+ε_{XY}γ−ε_{ZB}l_{XB}−ε_{ZZ}l_{XB}+l_{ZB}(ε_{XB}+ε_{XZ}+s_{XZ})cos θ−(ε_{XB}l_{XB}+ε_{XZ}l_{XB}+ε_{ZB}l_{ZB}+ε_{ZZ}l_{ZB}+s_{XZ}l_{XB})sin θ}(y−y₀),
where δⱼᵢ is a translational error of the drive axis i in a direction of j,
εⱼᵢ is an angular error of the drive axis i in the direction of j,
sⱼᵢ is the squareness of the drive axis i in the direction of j,
x, y, and z are coordinates of the circular path, and
x₀, y₀, and z₀ are center coordinates of the circular path,
p=δ_{XY0}+δ_{XZ0}−εZY0y₀−δ_{YY0}z₀,
q=−δ_{YY0}+δ_{YZ0}ε_{XY0}z₀,
r=−δ_{ZY0}+δ_{ZZ0}+ε_{XY0}y₀,
x=−l_{ZB} sin θ, y=0, x₀=0 and y₀=0.
